(19) United States
(12) Patent Application Publication
(10) Pub. No.: US 2013/0099084 A1
(43) Pub. Date: Apr. 25, 2013

(54) Modular Beverage Dispenser Support, Coupler and Method of Use Thereof

(71) Applicant: Cal Davis, Victoria (CA)

(72) Inventor: Cal Davis, Victoria (CA)

(21) Appl. No.: 13/645,041

(22) Filed: Oct. 4, 2012

(30) Foreign Application Priority Data
Oct. 20, 2011 (CA) 2656468

(51) Int. Cl. A47G 29/00; F16B 17/00

(52) U.S. Cl. CPC A47G 29/00; F16B 17/00
USPC 248/346.5; 403/292

(57) ABSTRACT

A modular beverage dispenser support is described which includes a polygon body having a dispenser support surface surrounded by a plurality of vertical side walls. A coupling receiver is recessed into at least one of the side walls to allow coupling with another polygon body having a like coupling receiver. There is described a number of configurations that can be created by using the coupling receivers to connect select sides of two or more beverage dispenser supports.

### RELATED APPLICATIONS

This application claims priority to Canadian Patent Application Serial Number 2,756,468, filed Oct. 20, 2011, which is incorporated herein in its entirety.

### FIELD

The present technology is a beverage dispenser support having a coupling member on at least one side wall. More specifically, the technology is a combination comprising at least two beverage dispensers coupled by a female to double male to female connector.

### BACKGROUND

Beverage dispenser supports are used to support beverage dispensing containers, such as airpots and coffee pots. These can be provided as individual units or a plurality of units. The prior art includes units that are linked to one another by means of a wire connector, or are permanently affixed to one another.

Another feature of the supports is that they may have a drip pan which is either integral with the support or is provided as a separate unit. These are often very similar to those employed in drink vending machines.

### SUMMARY

According to one aspect, there is provided a modular beverage dispenser support which includes a polygon body having a dispenser support surface surrounded by a plurality of vertical side walls. A coupling receiver is recessed into at least one of the side walls to allow coupling with another polygon body having a like coupling receiver.

The coupling receivers on the side walls of the polygon body can be used to couple the beverage dispenser supports in a variety of different ways, as will hereinafter be further described. There can be variations in the coupling receivers without adversely effecting their functioning. There will hereinafter be further described coupling receivers that have provided beneficial results which are in the form of a coupling slot extending across a face of each of the remaining side walls, each coupling slot having an entry end and peripheral edge retainers. It is preferred that each coupling slot extend upwardly from an entry end positioned toward a bottom of the polygon body. This is aesthetically more pleasing, but is not essential.

The modular beverage dispenser support which will be hereinafter described is in the form of a hexagon. This was merely a matter of design choice and is not essential. It is not practical to illustrate all of potential polygon body shapes. It is theoretically possible to have a polygonal body with sixty-four sides. However, it will be recognized that as the number of sides increase, practicality decreases as the size of the coupling receiver is reduced and health concerns surrounding effective cleaning arise. The preferred polygonal body shapes that have been used are a triangle, a rectangle, a pentagon, a hexagon, a heptagon, an octagon or a decagon.

According to another aspect of the invention there is provided the various potential combinations of beverage dispenser supports. Each combination will involve more than one modular beverage dispenser support, as described above. To complete the combination, two or more beverage dispenser supports are coupled. This is done with a double male coupling having two male coupling members. One of the two male coupling members is coupled with the coupling receiver on one of the side walls of the polygon body of one modular beverage dispenser support and another of the two male coupling members is coupled with the coupling receiver on one of the side walls of the polygon body of another modular beverage dispenser support.

Just as there is some variation possible with the configuration of coupling receiver used, as long as the double male coupling is compatible with the coupling receiver used, it too may be varied. A double male coupling which will hereinafter be further described and which has provided beneficial results has male coupling members which are elongated biscuits connected by a connective web. It should be noted that it is not essential that the polygonal bodies be the same shape. There is no reason why a hexagonal body could not be coupled to a octagonal body, as long as there are compatible coupling receivers that a double male coupling can engage.

Although there will hereinafter be described a number of combinations of beverage dispenser supports which can be achieved using the polygon bodies having side walls with coupling receivers, it will be understood that the illustrations provided are not exhaustive. Using a hexagon body for illustration, there will hereinafter be described beverage dispenser supports coupled to form a staggered row of alternating leading and trailing beverage dispenser supports. There will hereinafter be described beverage dispenser supports coupled to form a V shaped configuration. There will hereinafter be described beverage dispenser supports coupled to form an alternating row of beverage dispenser supports with a first group of beverage dispenser supports having drip trays in a first directional orientation and second group of beverage dispenser supports having drip trays in an opposed directional orientation. There will hereinafter be described beverage dispenser supports coupled to form a circle with drip trays extending outwardly from a notional center of the circle. Using an octagon body for illustration, there will be illustrated beverage dispenser supports in side by side relation.

According to a final aspect, there is provided a method of coupling beverage dispenser supports. This involves firstly providing more than one modular beverage dispenser support as described above. Secondly, placing side walls of two beverage dispenser supports in face to face relation. Thirdly, inserting a double male coupling, as described above, with one of the two male coupling members being coupled with the coupling receiver on one of the side walls of the polygon body of one of the two beverage dispenser supports and another of the two male coupling members being coupled with the coupling receiver on one of the side walls of the polygon body of another of the two beverage dispenser supports.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is an exploded perspective view of a beverage dispenser support.

FIG. 2 is a front elevation view of the beverage dispenser support of FIG. 1, shown supporting an airpot.

FIG. 3 is a perspective view of a riser component of the beverage dispenser support of FIG. 1.

FIG. 4 is a perspective view of a base component of the beverage dispenser support of FIG. 1.

FIG. 5 is a side elevation view of the base component of FIG. 4.

FIG. 6 is a perspective view of a drip tray component of the beverage dispenser support of FIG. 1.

FIG. 7 is a perspective view of a double male biscuit coupling component of the beverage dispenser support of FIG. 1.

FIG. 8 is a top plan view of the double male biscuit coupling component of FIG. 9.

FIG. 9 is a plan view of a flavor display tag.

FIG. 10 is a side view of a flavor display tag.

FIG. 11 shows an octagonal version of the riser.

FIG. 12 shows a perspective view of the beverage dispenser of FIG. 1, showing the Paddle board holder.

### DETAILED DESCRIPTION

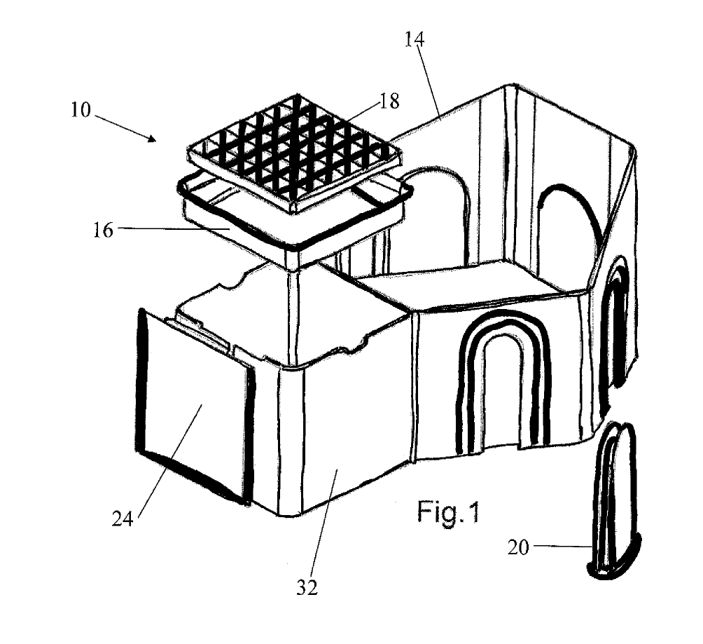

A beverage dispenser support generally identified by reference numeral 10, will now be described with reference to FIG. 1 through 11.

### Structure and Relationship of Parts:

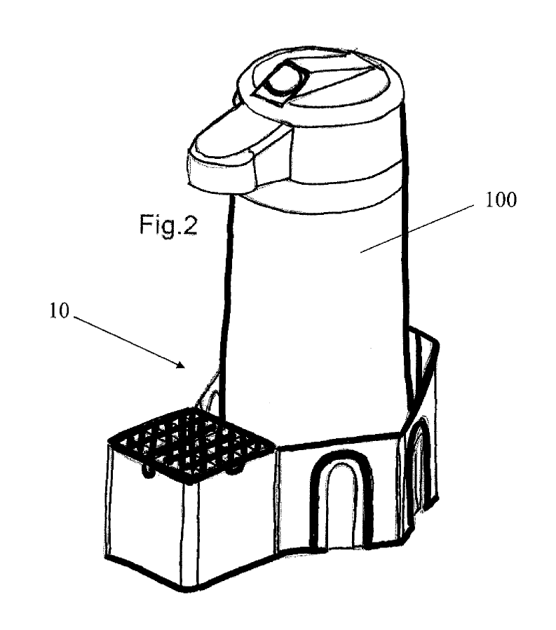

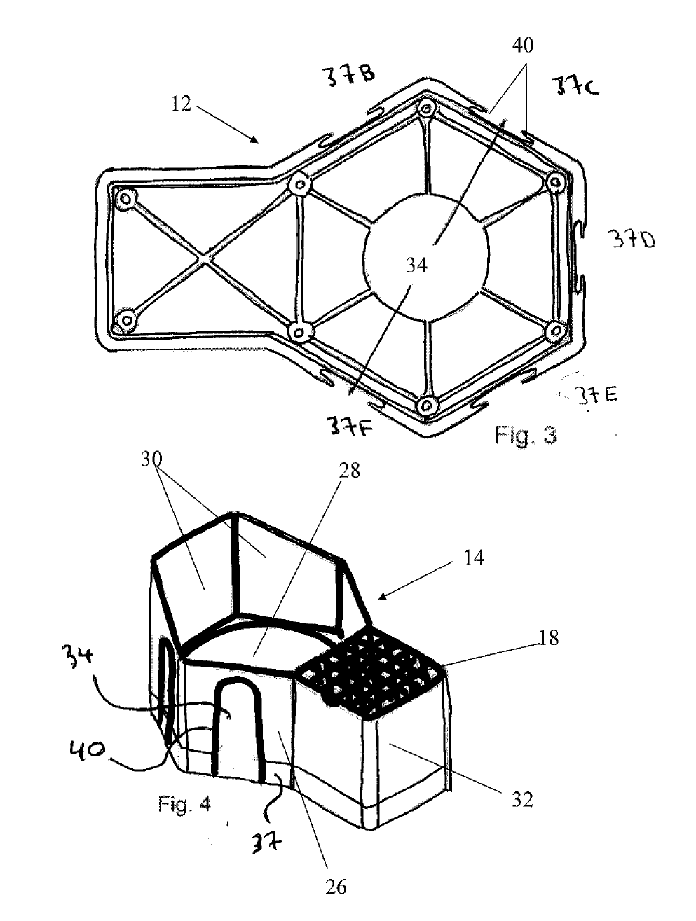

Referring to FIG. 1, a preferred version of beverage dispenser support 10 is illustrated in an exploded view that shows its components as including a base 14, a drip tray 16, an egg-crate grid 18, a double male biscuit coupling 20 and a flavour identification tag holder 24. For clarity, each of these components is also independently illustrated. Referring to FIG. 2, beverage dispenser support 10 is intended to support a beverage dispenser. An airpot style dispenser 100 has been illustrated to show the normal function of beverage dispenser support 10. Referring to FIGS. 3 and 4, a riser 12 is illustrated. Riser 12 is an underlying support. The riser 12 may not be included in the support 10, or there may be one to multiple risers 12 used. It is a desirable component as it can be equipped with non-slip bottom feet and can be removed for cleaning. Riser 12 has features to enable it to function with base 14. Slots that function as coupling receivers 34 extend the height of the riser walls 37 and have peripheral edge retainers 40. There is a coupling receiver 34 on each riser wall 37. The riser walls are identified by letters in a clockwise fashion as 37B, 37C, 37D, 37E, and 37F.

Referring to FIG. 1, drip tray 16 and egg-crate grid 18 are shown in exploded view in their relative positions. Referring to FIG. 4, base 14 is the main component of beverage dispenser support 10. Base 14 has a polygon body 26. In FIG. 1 through 5 polygon body 26 as hexagonal. Polygon body 26 has a dispenser support surface 28 upon which airport style dispenser 100 is intended to be position. Support surface 28 is surrounded by a plurality of vertical side walls 30. Referring to FIG. 3, in a description of operation which follows each of side walls 30 will be further identified by a letter of the alphabet to assist in identifying various configurations. A support structure 32 for drip tray 16 is provided along one of side walls 30, for the purpose of the description of operation, this side wall will be designated as 30A. The remaining side walls are identified by letters in a clockwise fashion 30B, 30C, 30D, 30E, and 30F. It will be appreciated that the hexagon shape was merely a matter of design choice from a plurality of potential polygon shapes and is not essential. It is not practical to illustrate all of potential polygon body shapes. It is theoretically possible to have a polygonal body with sixty-four sides. However, it will be recognized that as the number of sides increase, practicality decreases as the size of the coupling receiver is reduced and health concerns surrounding effective cleaning arise. It is preferred that the polygonal body is a triangle, a rectangle, a pentagon, a hexagon, a heptagon, an octagon or a decagon.

Referring to FIGS. 3-5, a coupling receiver, generally indicated by reference numeral 34, is recessed into the remaining side walls to allow coupling with another polygon body having a like coupling receiver. It is preferred, but not essential that coupling receiver 34 be on each of remaining side walls 30B, 30C, 30D, 30E and 30F. Functionality can be provided as long as a coupling receiver 34 is provided on at least two of the remaining side walls. Coupling receiver 34 can be varied and need not be identical to what has been shown. As Illustrated, coupling receiver 34 is in the form of a slot which extends upward from the bottom 36 of each of the side walls 30. The slot has an open entry end 38 and peripheral edge retainers 40 (see FIG. 3 where the same peripheral edge retainers are shown in the riser). While it is preferred that entry end 38 be positioned at the bottom 36 of the side walls 30, it may equally be positioned at the top 35 of the side wall 30 and extend downwardly or horizontally. Locating the entry end 38 at the bottom 36 of the side walls has the advantage of reducing the chance of pilfering as the double male biscuit coupling 20 cannot simply be lifted out, as the support 10 sits upon the base of the coupling 20. Also, the double male biscuit coupling 20 will not disengage from the slot that serves as coupling receiver 34 if beverage dispenser support 10 is bumps and pushed laterally. When not in use, coupling receiver 34 provides an aesthetically pleasing ornamental aspect to side wall 30.

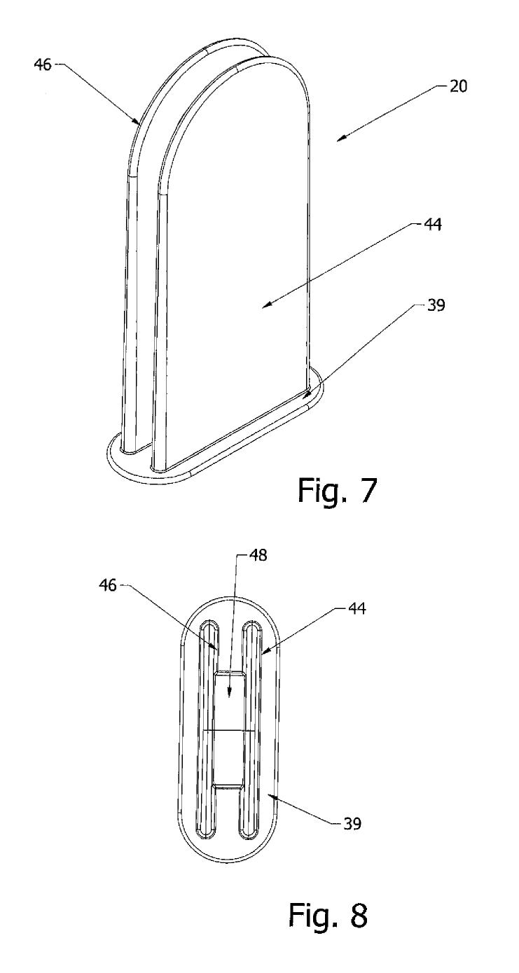

The functioning of peripheral edge retainers 40 can be better understood by reviewing the structure of double male biscuit coupling 20, which will hereinafter described and illustrated with reference to FIGS. 7 and 8. The double male coupling 20 consists of a base 39, and parallel elongated biscuits 44 and 46 connected by a connective web 48. The base 39 offers the advantage that it can be used to attach the coupling 20 by a cord or wire to the support 10 by drilling a hole in the base or gluing or otherwise affixing the cord or wire to the base, again reducing the chance of theft. As discussed above, the support 10 (or riser 12) may sit directly on the base 39. The base 39 also functions to locate the coupling 20 in the slot or slots thereby ensuring that it does not inadvertently release the support 10. As is apparent, the length of the coupling 20 depends upon whether none, one or more risers 12 are used. The coupling 20 need not extend the total slot 34 length, but needs to engage at least a part of the slot 34 of the support 10.

The double male coupling 20 slides into the slot that serves as the coupling receiver 34. Referring to FIG. 3, it will be understood that male coupling 20 can move longitudinally within the coupling receiver 34, with peripheral edge retainers 40 preventing biscuits 44 and 46 of male coupling 20 exiting laterally from the slot that serves as the coupling receiver 34. Referring to FIG. 6, the only manner of ingress and egress from the slot that serves as coupling receiver 34 is through the entry end 38. To be clear, coupling is releasable. When engaged with coupling receiver 34, double male coupling 20 holds side walls 30 of face to face beverage dispenser supports 10 in a fixed relation. It should be noted that it is not essential that the polygonal bodies be the same shape for a coupling to occur. There is no reason why a hexagonal body could not be coupled to an octagonal body, as long as there are compatible coupling receivers 34 that the double male coupling 20 can engage.

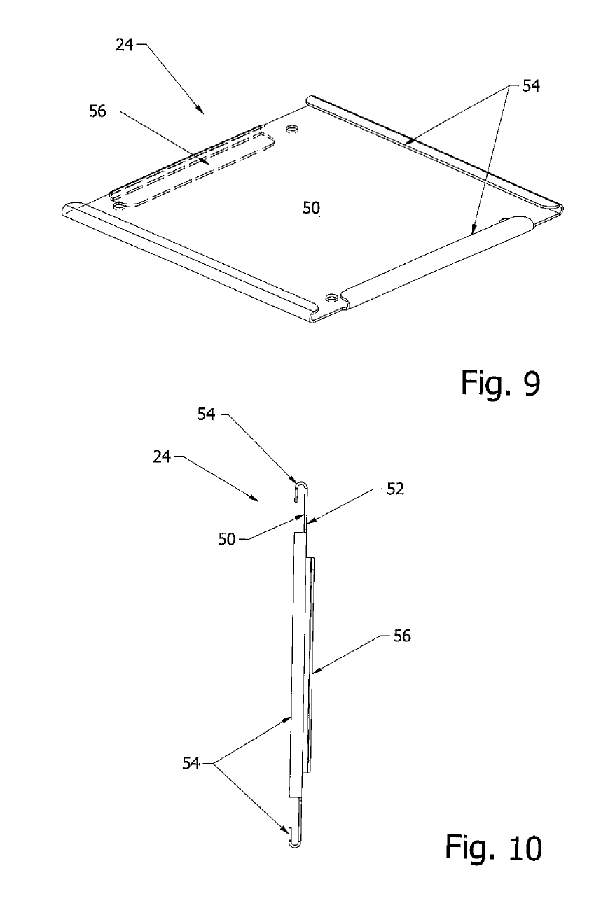

Referring to FIGS. 9 and 10, there is illustrated a flavour identification tag holder 24. Flavoured identification tag holder 24 has a front face 50 and a back face 52. A peripheral border 54 encloses front face 50 on three sides. A hook 56 extends from back face 52. Referring to FIG. 1, a flavour identification tag is held against front face 50 by peripheral border 54. Hook 56 is used to hook onto support structure 32 for drip tray. As the name suggests, flavour deification tag holder 24 is used to hold within peripheral border 54 a flavour identification tag (not shown) which identifies the type and flavour of beverage being dispensed.

### Operation:

There will now be described how the features described above can be used to form combinations of beverage dispenser supports to meet the needs of customers. The customers are, typically, involved in catering or retail sales of beverages in self serve restaurants, cafeterias and convenience stores.

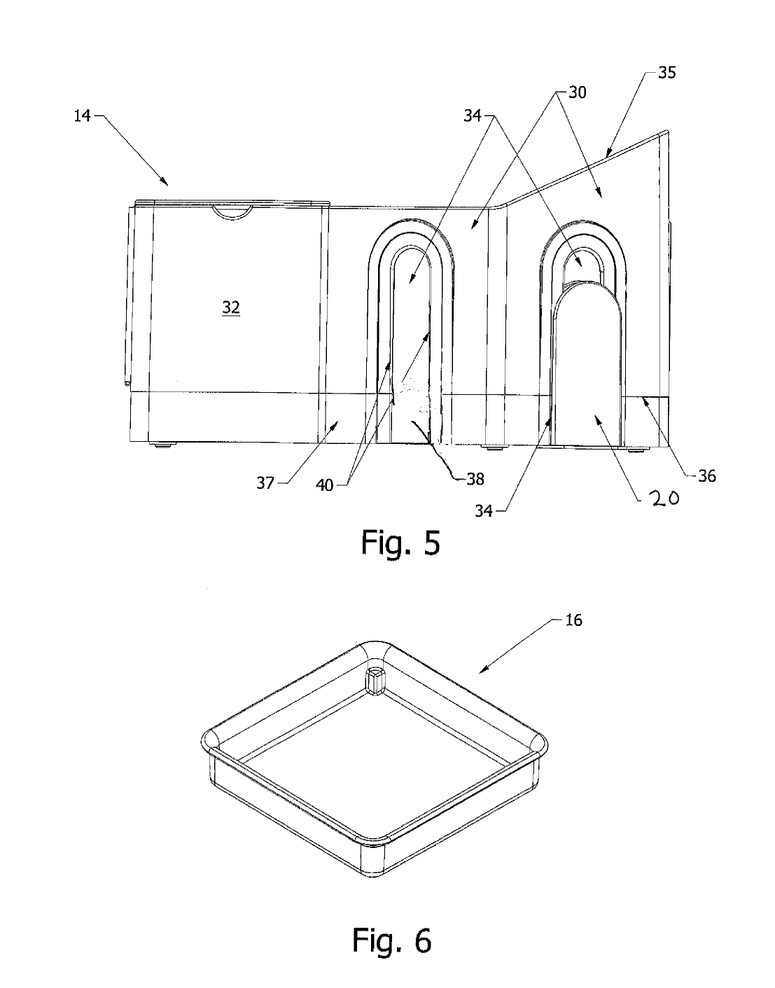

The actual coupling of bases 14 of adjacent beverage dispensers is accomplished by sliding double male coupling 20 into coupling receivers 34. Referring to FIG. 3, peripheral edge retainers 40 prevent double male coupling 20 from passing laterally out of the slot that serves as coupling receiver 34. Referring to FIG. 5, the only manner of ingress and egress from the slot that serves as coupling receiver 34 is through entry end 38. Referring to FIGS. 7 and 8, when double male coupling 20 is inserted into coupling receivers 34 of adjacent bases 14, biscuits 44 and 46 each engage one of coupling receivers 34. Referring to FIGS. 7 and 8, the connective web 48 maintains biscuits 44 and 46 in parallel spaced relation. This maintains bases 14 in a fixed face to face relation.

It will be understood that the illustrations provided are not exhaustive and are only intended to demonstrate the utility of the invention.

Two beverage dispenser supports with polygon bodies that are hexagonal can be joined by coupling the side wall 30B of a first 10 of the two beverage dispenser supports to the side wall 30E of a second 10 of the two beverage dispenser supports.

Three beverage dispenser supports with polygon bodies which are hexagon can be joined. Side wall 30B of a first 10 of the three beverage dispenser supports being coupled to side wall 30E of a second 10 of the three beverage dispenser supports and with side wall 30F of first 10 of the three beverage dispenser supports being coupled to sidewall 30C of a third 10 of the three beverage dispenser supports.

There can be coupled a staggered row of alternating leading and trailing beverage dispenser supports. The row can be of indeterminate length and involving an indeterminate number of beverage dispenser supports. Side walls 30C and 30E of leading beverage dispenser supports 10 being coupled to side walls 30F and 30B, respectively, of trailing beverage dispenser supports 10.

There can be coupled an alternating row of beverage dispenser supports 10 of indeterminate length with a first group of beverage dispenser supports 10 having drip tray supports 32 in a first directional orientation and second group of beverage dispenser supports 10 having drip tray supports 32 in an opposed orientation. Side walls 30B and 30F of first group of beverage dispenser supports 10 being coupled to side walls 30B and 30F, respectively, of second group of beverage dispenser supports 10.

There can be coupled a V shaped configuration of an indeterminate number of beverage dispenser supports. The V shaped configuration has an apex beverage dispenser support 10 and a series of beverage dispenser supports 10 forming a first arm and a series of beverage dispenser supports 10 forming a second arm. Side wall 30C of apex beverage dispenser support 10 and each beverage dispenser support 10 forming the first arm are coupled to side wall 30F of a next of the beverage dispenser supports 1Y forming the first arm. Side wall 30E of apex beverage dispenser support 10 and each beverage dispenser support 10 forming the second arm are coupled to the side wall 30B of a next of beverage dispenser supports 10 forming the second arm.

There can be coupled a circle of beverage dispenser supports with drip tray supports 32 extending outwardly from a notional center of the circle. Side walls 30C and 30E of each of beverage dispenser supports 10 being coupled to side walls 30E and 30C, respectively, of adjacent beverage dispenser supports.

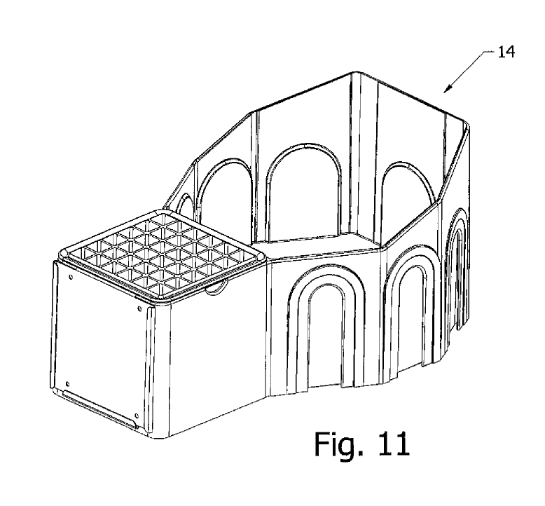

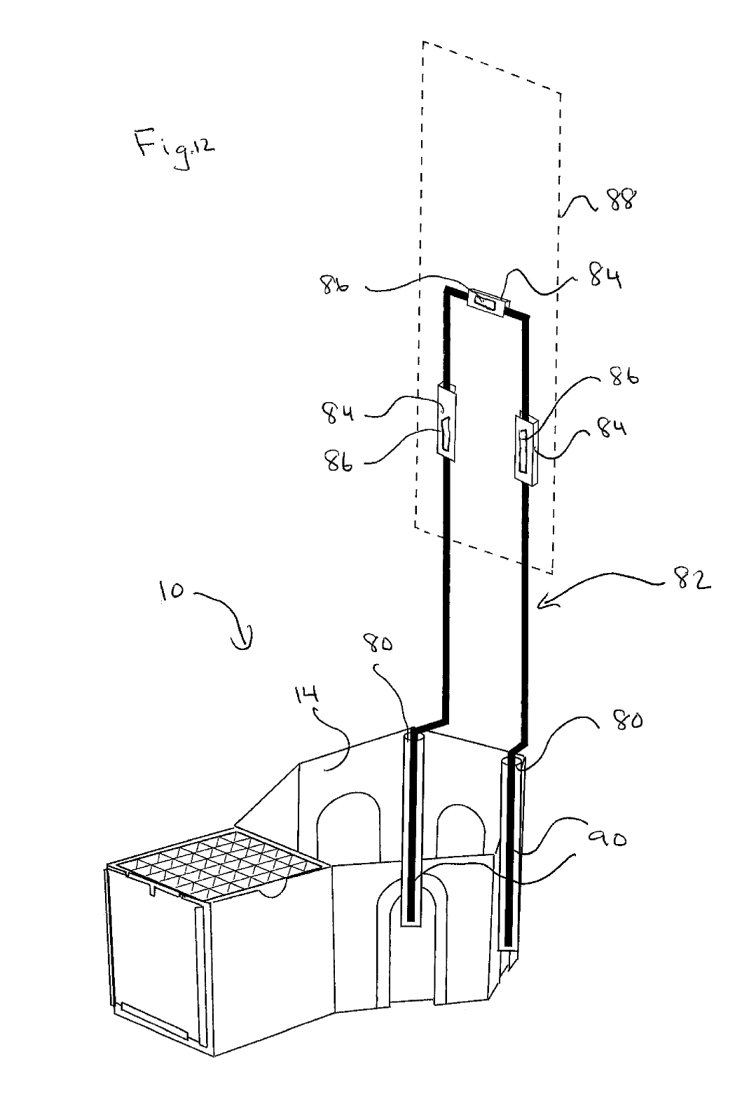

Referring to FIG. 11, there is illustrated a base 14 with respect to which the polygonal body is octagonal. This is the preferred shape. The octagon bodies may be arranged in straight row in side by side relation. This straight row arrangement is not possible when the polygon body is a hexagon and is also not possible with a number of other polygon bodies.

As shown in FIG. 12, the base 14 of the beverage dispenser support 10 has a holder acceptor 80, which in the illustrated embodiment is two tubes, for accepting a holder, generally referred to as 82. The holder 82 is fitted with three clips 84, each which has double edged tape 86 or a similar adhesive or attachment means. For example, Velcro® or glue could be used. The holder 82 is shaped to hold and display a “Point of Sale” Paddle board 88 (as shown as a dashed line). Legs 90 of the holder 82 fit into the tubes 80. As would be known to one skilled in the art, the base 14 may have a slot rather than two tubes, or may have three or more tubes. Similarly, the holder need only be shaped to slide or slot into the holder acceptor 80. The significant feature of the holder acceptor 80 is that it must retain the wire holder in a forward orientation, relative to the beverage dispenser 100.

### Variations:

The illustrations show beverage dispenser support 10 made out of polymeric plastic material. It will be apparent to one skilled in the art that the teachings disclosed are not limited to beverage dispenser supports made from particular materials. The beverage dispenser supports could be made out of the wood, metal, wire or other suitable materials. Beverage dispenser support 10 chosen for illustration is hexagonal.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The illustrated embodiments have been set forth only as examples and should not be taken as limiting a purposive interpretation of the claims.

1. A modular beverage dispenser support, comprising:
a polygon body comprising a dispenser support surface and a plurality
of vertical side walls surrounding the dispenser support surface, the vertical side walls having a bottom and a top; and
a coupling receiver in at least two of the side walls.

2. The modular beverage dispenser support of claim 1, wherein the coupling receiver is an open ended slot.

3. The modular beverage dispenser support of claim 2, wherein the slot comprises peripheral edge retainers.

4. The modular beverage dispenser support of claim 3, wherein the slot extends upwardly from an entry end at the bottom of the side wall.

5. The modular beverage dispenser support of claim 3, wherein the slot extends downwardly from an entry end at the top of the side wall.

6. The modular beverage dispenser support of claim 4, wherein a support for a drip tray is integral with one of the side walls.

7. A combination for use in dispensing beverages, the combination comprising:
(i) more than one modular beverage dispenser support, each modular beverage dispenser support comprising:
a polygon body comprising a dispenser support surface and a plurality of vertical side walls surrounding the dispenser support surface, the vertical side walls having a bottom and a top; and
a coupling receiver in at least two of the side walls; and
(ii) at least one double male coupling comprising two male coupling members, one of the two male coupling members being coupled with the coupling receiver on one of the side walls of the polygon body of one modular beverage dispenser support and another of the two male coupling members being coupled with the coupling receiver on one of the side walls of the polygon body of another modular beverage dispenser support, such that in use, the modular beverage dispenser supports are releasably attached to one another.

8. The combination of claim 7, wherein the coupling receiver is an open ended slot.

9. The combination of claim 8, wherein the slot comprises peripheral edge retainers.

10. The combination of claim 9, wherein the male coupling members of each double male coupling are elongated biscuits connected in parallel relation by a connective web.

11. The combination of claim 10, wherein the double male coupling further comprises a base.

12. The combination of claim 11, wherein the polygon body is an octagon.

13. The combination of claim 12, wherein the beverage dispenser supports are coupled in a straight row in side by side relation.

14. A releasable coupler for coupling a first wall to a second wall, the coupler comprising:
(i) a coupling receiver in each of the first wall and the second wall, the coupling receiver being an open ended slot extending from either a top or a bottom of each of the first wall and the second wall; and
(ii) a double male coupling comprising a base, two elongated biscuits and a connective web, wherein the two elongated biscuits are connected in parallel relation by the connective web.

15. The releasable coupler of claim 14, wherein the slot comprises peripheral edge retainers.

16. The releasable coupler of claim 15, wherein the slot extends upwardly from an entry end at the bottom of the side wall.

17. The releasable coupler of claim 15, wherein the slot extends downwardly from an entry end at the top of the side wall.
